(19) United States
(12) Patent Application Publication
(10) Pub. No.: US 2007/0220092 A1
(43) Pub. Date: Sep. 20, 2007

(54) SYSTEM, APPARATUS AND METHOD FOR ENABLING MOBILITY TO VIRTUAL COMMUNITIES VIA PERSONAL AND GROUP FORUMS

(75) Inventors: Joe Heitzeberg, Seattle, WA (US); Thomas Jay Hoover, Seattle, WA (US); Nathan Kriege, Seattle, WA (US); Robert Frederick, Seattle, WA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Snapvine, Inc., Seattle, WA (US)

(21) Appl. No.: 11/674,555

(22) Filed: Feb. 13, 2007

Related U.S. Application Data
(60) Provisional application No. 60/773,041, filed on Feb. 14, 2006.
(60) Provisional application No. 60/773,042, filed on Feb. 14, 2006.
(60) Provisional application No. 60/773,229, filed on Feb. 14, 2006.
(60) Provisional application No. 60/773,230, filed on Feb. 14, 2006.

(51) Int. Cl. G06F 15/16

(52) U.S. Cl. 709/204

(57) ABSTRACT

A system and associated apparatus and methods for enabling members of a group or virtual community to create and access voice messages, audio, video, text or other content over the Internet. The invention provides a model of a voice bulletin board or forum in which multiple members of a group may create and post messages or other content that may be accessed, commented upon, or supplemented by other group members. The invention enables group members to input the message or content using a fixed-line (e.g., wireline) or wireless device, such as a standard phone, wireless mobile phone, or wirelessly connected computing device equipped with a microphone. The invention further enables a group member to create a forum and provide access to that forum to other group members, and to provide notifications to group members when new messages or content are posted to the forum.

### CROSS-REFERENCE TO RELATED APPLICATIONS

The present application is related to and claims the benefit of the following United States Provisional Patent Applications, the contents of each of which are hereby incorporated by reference: U.S. Provisional Patent Application No. 60/773,041 entitled “Voice Forums” and filed Feb. 14, 2006, U.S. Provisional Patent Application No. 60/773,042 entitled “Web Authorization by Automated Interactive Phone or VoIP Session” and filed Feb. 14, 2006, U.S. Provisional Patent Application No. 60/773,229 entitled “Interactive Messaging System” and filed Feb. 14, 2006, and U.S. Provisional Patent Application No. 60/773,230 entitled “Apparatus and Method for Obtaining Audio Content for a Web Application by Dialing Out to a Phone” and filed Feb. 14, 2006.

### BACKGROUND OF THE INVENTION

The present invention is directed to systems, apparatus and methods for enabling groups of individuals to communicate over a wireline, wireless, and/or internet-enabled network, and more specifically, to a system, and associated apparatus and methods for creating, managing, and providing access to voice messages and other media content to enable members of a virtual community or social network to interact with the messages or content.

Communication between members of a group serves many useful and important functions. These include the exchange of information, as well as stimulating the creation of and reinforcing bonds between individual group members in order to maintain the group structure. Communication also enables individuals to express their individuality and opinions, and thus furthers broader social goals. Thus, it is no surprise that with the increasing popularity of the Internet and other types of networks and applications that link large numbers of users, communities of users have formed. Some of these communities have common interests and wish to exchange information about those interests, while others are formed as a way to facilitate introductions or to pursue some value expected in the future (e.g, a job, discovery of content, etc.).

A virtual or online community is a term used to refer to a group of individuals that are linked in some way online, such as over the Internet. It is not a physical community in the sense of all members being located within some geographical boundary, but instead is a set of individuals located in multiple physical locations but linked together by a common interest and/or membership in some group. The community members primarily interact by communicating over the network instead of face-to-face. The modes of communication and interaction over the network (e.g., the Internet) vary, and may include email, text messaging, web logs (blogs), chat, instant messaging, and/or expressive HTML web pages that contain text, javascript widgets, graphics, personal photos, or embedded applications (e.g., FLASH). Online communities have also become a supplemental form of communication between people who know each other in real life and as such have the opportunity to communicate face-to-face. In either case, the inherent nature of the Internet enables groups of people to communicate electronically, anonymously, and in the privacy of their own “safe environments” rather than face to face.

Regardless of the type of community, the variety of available modes of communication and the richness and effectiveness of those modes contribute to the cohesiveness of the community and to individuals' desire to join and remain part of the community. This is particularly important and valuable in situations where the value of community membership is enahnced by the “network effect”, i.e., where the value or benefit of membership scales non-linearly with the number of members.

One popular type of online community is that termed a “social network”. This term is used to refer to a variety of social groups interacting via the Internet. Such virtual communities may form when people carry on public discussions that spark interest and cater to people's desire to become involved and part of the discussion, as in a set of postings on a bulletin board or similar model. Such communities may be characterized by a set of interchanging, numerous personal relationships between people that have found a common platform to discuss their interests, concerns, passions, etc. In this regard, one of the first forms of group communication was enabled via the “bcc” and “cc” fields of standard email. By including multiple people on a recipient list, a single text message could be sent to a large group of people and spark numerous responses from what was an informal “network” of known peers or relative strangers. The email program that acts to enable and facilitate (or “mediate”) the community is a simple form of social networking software.

Over the years, social networking software has developed from the relatively simple form of an email application to applications that leverage the power and distributed nature of the Internet, and act to increase the likelihood of communities of people being able to interact based upon the common interests or characteristics of the individual members of the community. Such communities may reduce the sense of isolation felt by some individual members, foster a sense of belonging, and decrease the turnover rate of membership by allowing for viral adoption of the software's features and services. Thus, one possible definition of a social network is when users leverage an internet-connected application to form an online “computer mediated” community. In such situations, social networking software may act to regulate the activities of its participants, and significant socio-technical and socio-behavioral change has been noted to result from the proliferation of such Internet-based social networks.

Note that in one sense, virtual communities are created whenever multiple users go onto a website and create accounts on a website. In this sense, the website does not necessarily have to be a traditional social network site. For instance, after creating an account with an on-line seller such as Amazon.com™, the registered user can now interact with other registered users, influencing their behavior based upon reviews, purchases, and ratings. A similar possibility occurs when a user creates an E-trade™ account, and/or an account on other e-commerce/financial accounts. News, radio, and other media interfaces that include broadcast data over various mediums also generate virtual social and virtual community networking effects.

In order to facilitate community membership and increase cohesiveness, there is an inherent need for members of virtual communities to have a wide variety of modes available in which they can communicate. This results in a drive to develop efficient, new, rich, and expressive communication modes that allow individuals to differentiate themselves from other members of the community, and tends to lead to the development of technologies that foster sharable and open communication. This is because virtual communities depend upon social interaction and the exchange between users. Further, in such communities, there is an implied reciprocity obligation between members that serves as an unwritten social contract between community members. This reciprocity obligation acts to encourage initial membership and foster active involvement with the community. Currently, there are several popular and successful social networks that breed viral virtual communities: MySpace.com, Bebo.com, Orkut.com, Flicker.com, Classmates.com, and Facebook.com, for example. These communities compete for members by enabling features and leveraging techniques that increase interaction, which ultimately increases their membership and the value of that membership to each member. One component of social networks is that a single individual may be a member of multiple social networks, leveraging features of one network to communicate with individuals in one environment, while communicating with other people in a different network or community whose features and services might be the same as, or different than those of the first community.

Different virtual communities foster different levels of interaction and participation among their members. Some websites (i.e., social networks) are designed to encourage members to interact via “tagging” content for classification and easy discovery purposes. Other websites rely upon members rating content produced by other members. Still others require members to invite other members to connect before allowing any form of communication to occur. Just like traditional social groups and clubs, virtual communities divide themselves into cliques or even seperate to form new sub-communities of like-minded individuals. By enabling like-minded individuals to search, find, and discover people that they would not likely have come into contact with without the use of a networked computer, social networks have grown in popularity among a younger demographic, while continuing to gain traction with older generations.

Virtual networks or communities are generally not prone to geographic or temporal limitations or constraints. And, although the ability to interact instantaneously at any time from anywhere on the globe has considerable benefits, in some situations virtual communities have generated criticism from individuals who are accustomed to more traditional forms of communication. There is some reason for concern as virtual communities may be mis-used to serve as hunting grounds for online criminals, identity thieves, and stalkers, with children particularly at risk. Some fear that spending too much time in virtual communities may have negative repercussions on real-world interaction. Thus, the need to ensure that community members can interact in safety, remain anonymous, and still foster strong relationships with their like-minded sub-communities is something that social networks are trying to achieve. However, software and tools that support open communication and the formation of virtual communities are typically lacking this combination of core features.

As with real life, there are numerous reasons why people are motivated to contribute and participate in virtual communities. One of the most common reasons that people contribute is because they want to build the most complete online repository of information that they and their peers can use. The larger the number of contributors, the more coverage these Internet authors can have available on any subject, idea, or concept of interest. In this regard, Wikipedia.com, Slashdot.com, and Usenet are examples of communities built upon the concept of sharing knowledge among its members. Another reason why people join and contribute to online communities is because they have an inherent belief that if they participate in a discussion, tag someone else's content, or write a blog, other community members will demonstrate reciprocity. This means that by becoming involved and providing information that enhances another's content, members of the community will feel an obligation to enhance the content that the person has created themselves. Evidence of this exists in the simple analysis that the most active participants on any social network tend to get the fastest responses to questions and the most number of messages from other members of their online community.

Even though social networks may allow individuals to express themselves via graphics, pictures, audio, or video, the primary form of communication between members remains text based. Members typically sit at a computer, use Internet access software, and type messages to one another. There are millions of text messages being passed between online community members daily with every member having a computing device, a computer monitor, a keyboard, and an Internet connection. Typically, those with the fastest Internet connections tend to tire of simple text-based communication. They tend to purchase software and peripherals for their computer and desire a richer and more complete form of communication.

In addition to text based communication, voice or audio communications using a microphone over an Internet connection have recently increased in popularity. In this mode of communication, users purchase and install software on their computers that enables them to talk to other members of their virtual networks in the same manner that they would over a traditional telephone line. However, the quality of the experience is usually impacted by the Internet connections of each participant. People with slow connections tend to have poor, delayed communications with their peers, while people with fast Internet connections tend to have an experience comparable to communicating over a land-line phone. Further, the growth in adoption of computer/microphone based communication between online members of virtual communities has been stymied by the difficulty in using the required hardware, the difficulty in properly installing and using the software, and most importantly, the fact that most members of the community tend to not have the capability to communicate in this manner. The same problems apply in the case of community members' attempts to communicate via a video channel.

One existing form of voice or audio communication that may be used by members of a group is that of a Phone Voicemail System. These systems are designed to accommodate one user per voice mail box and are usually accessed only by a phone (receiving and sending). The systems may be viewed as a “many to one” model since many people may leave messages, although the messages are generally intended for and accessible by a single person. Thus, although such systems provide a way to produce and access voice messages, they do have limitations and disadvantages. For example, for groups, or people whose primary connection to the group is through the Internet, this is inconvenient. Further, such systems limit the ability for certain types of group dynamics and interactions to occur. The normal exchange of comments or information that occurs within a group (a “many to many” model) is difficult if not impossible to effectively simulate with such systems. Other disadvantages of typical voice mail systems include: (1) If a voice mail message is deleted by any user, all users are unable to hear it; (2) The only way to leave a message is by dialing a known or shared phone number; and (3) The only way to listen to a message is by dialing a known or shared phone number. Voicemail systems are typically associated with someone's personal phone number. Combined with disadvantages (2) and (3) above, such systems offer little to no security or privacy for the owners of the voice messaging system if all users of that system must have the owners' personal phone numbers in order to use the system.

Voice over Internet Protocol (VoIP) refers to the method mentioned above of providing voice communication services over a different channel than is used for standard telephone services. Using the Internet as a communications channel, the VoIP service is able to leverage the benefits of well known protocols to enable the provision of voice and data communications over a common network. This permits the bundling of voice and data services over a common delivery channel, but also provides new and better services as a result of combining the traditional line of communication with the power of the computer software that enables the connections. By having the communication be computer-based, certain characteristics of the Internet, such as low cost data transmission and better user interfaces can be integrated with voice transmission services. Also, individuals who traditionally would not have the resources or ability to broker relationships with local and national Telecommunications Companies can now use VoIP to bypass a system that was exclusionary, expensive, and depending upon the country, controlled and regulated by the local and national governments. The characteristics of VoIP have provided an environment in which new services and business models can be implemented inexpensively by a growing number of small businesses to satisfy the needs of online and offline virtual communities.

In this regard, VoIP capable applications executing on personal computers have emerged and obtained traction in the marketplace. These applications enable services that permit person-to-person voice conversations which traditionally occurred over fixed line and wireless telecommunications networks to travel over the Internet at primarily the cost of the bandwidth they consume. Since most users pay a flat rate for Internet service (or none at all), the net effect of these VoIP services is a drastic reduction in the cost of voice communication services and the ability to freely communicate with international members of an online community via a voice channel, which would have been cost prohibitive prior to the advent of VoIP.

Even with the advancements and continuing proliferation of VoIP services, some problems still remain. One problem is that a vast majority of the VoIP applications available require a powerful enough computing device to run the necessary software. Typically, these devices are home (desktop) computers, but there has been a sharp increase in members of communities using their portable laptop computers to communicate with their peers and online communities while away from their home computer. Typically, these users leverage public or paid wireless (WiFi) connections, which tend to be less reliable than their personal (at home) connections. If users are paying for their wireless connections, then to be a desirable mode of communication, the overall cost and effort of transmitting audio content using bulky and cumbersome headphones and microphones must be less than that of picking up a traditional phone or cell-phone and contacting a person directly. In other words, the cumbersome nature of using VoIP and the cost associated with the necessary hardware and peripherals, particularly while mobile, has been and will continue to be a barrier to the adoption of VoIP for use in enabling communication among active members of social networks. In addition, presently available VoIP based communications applications are designed for real-time audio communications, and are therefore less desirable for some use cases, such as group members in different time zones or group discussions that evolve over the course of many days or weeks.

What is desired is a system and associated apparatus and methods of providing multi-media communication capabilities (audio, video, and/or text) to both mobile and online members of a group to enable the creation, management, and access of voice messages, audio, video, text or other content by those members, and which overcomes the disadvantages of present approaches.

### BRIEF SUMMARY OF THE INVENTION

The present invention is directed to a system and associated apparatus and methods for enabling members of a group or virtual community to create, manage, and access voice messages, audio, video, text or other content over the Internet. The invention provides a model of a voice bulletin board or forum in which multiple members of a group may create and post messages, audio, video, or other content that may be accessed, commented upon, or supplemented by other group members. The invention enables group members to input the message or content using a fixed-line (e.g., wireline) or wireless device, such as a standard phone, wireless mobile phone, or wirelessly connected computing device equipped with a microphone, camera, or video-camera. The invention further enables a group member to create a forum and provide access to that forum to other group members, and to provide notifications to group members when new messages or content are posted to the forum.

As the inventors of the present invention have recognized, it is currently difficult for groups of users who are distributed throughout the world and connected by a network such as the Internet to communicate with other members of their virtual community by voice, audio, or video using their Internet connection and fixed or mobile phone systems. The present invention is designed to provide a useful, convenient, and flexible way for users anywhere in the world, at anytime, to create, publish, and share multimedia content, and in doing so to satisfy the growing need for self-expression, group communication, and knowledge sharing for users of both the Internet and phone-based systems.

In one embodiment, the present invention is directed to a method of enabling members of a virtual community to interact via a communication forum, where the method includes enabling a first member of the community to establish a forum account, where the account is established at least in part by accessing a web-site over the Internet, enabling the first member of the community to provide content associated with the forum account, where the content includes audio content input to a telephony device, enabling a second member of the virtual community to access the content provided by the first member, enabling the second member to respond to the content provided by the first member by providing responsive content, providing a notification to the first member that the second member has provided responsive content, and enabling the first member of the community to access the responsive content.

In another embodiment, the present invention is directed to a system to enable members of a virtual community to interact via a communication forum, where the system includes a VoIP/PSTN gateway coupling a telephony network to the Internet and a Voice Applications element coupled to the Internet and configured to enable execution of a communication forum application, where the communication forum application includes a set of executable instructions, which when executed, implement a process that includes enabling a first member of the community to establish a forum account, where the account is established at least in part by accessing a web-site over the Internet, enabling the first member of the community to provide content associated with the forum account, where the content includes audio content input to a telephony device, enabling a second member of the virtual community to access the content provided by the first member, enabling the second member to respond to the content provided by the first member by providing responsive content, providing a notification to the first member that the second member has provided responsive content, and enabling the first member of the community to access the responsive content.

Other objects and advantages of the present invention will be apparent to one of ordinary skill in the art upon review of the detailed description of the present invention.

### BRIEF DESCRIPTION OF THE DRAWINGS

FIG. 1 is a functional block diagram illustrating the primary functional elements of a system that may be used to implement an embodiment of the present invention;

FIG. 2 is a flowchart illustrating an example process to enable a user to create a voice forum in accordance with an embodiment of the present invention;

FIG. 3 illustrates a registration process that may be utilized by a user as part of creating a voice forum in accordance with an embodiment of the present invention;

FIG. 4 illustrates an authentication process that may be utilized by a user as part of interacting with a voice forum in accordance with an embodiment of the present invention;

FIG. 5 illustrates a process for providing audio content to a web application using a phone as the input device;

FIG. 6 is a flowchart illustrating an example of how a visitor to a voice forum might interact with that forum in accordance with an embodiment of the present invention;

FIG. 7 is a flowchart illustrating an example of how a forum owner or creator might interact with that forum in accordance with an embodiment of the present invention; and

FIG. 8 is a flowchart illustrating an example of how a forum owner or creator might leave a message or content for a friend or group of friends in accordance with an embodiment of the present invention.

### DETAILED DESCRIPTION OF THE INVENTION

The present invention is directed to a system and associated apparatus and methods to enable members of a group or virtual community to engage in effective voice or multimedia communications. The invention creates a model of a voice bulletin board or voice forum which may be used by community members to create voice messages or multimedia content and enable those messages or content to be accessed, commented upon, or supplemented by other members of the community. The messages or content may be input using a variety of input devices, and may be provided over a fixed wireline or wireless network. The voice forum may be accessed via a phone or web-page, and its functionality may similarly be set or modified via a phone or web-page. The combination of flexible means of message or content input, and forum access and configuration produces a communications method that facilitates group dynamics and communication lacking in present voice based or audio messaging systems.

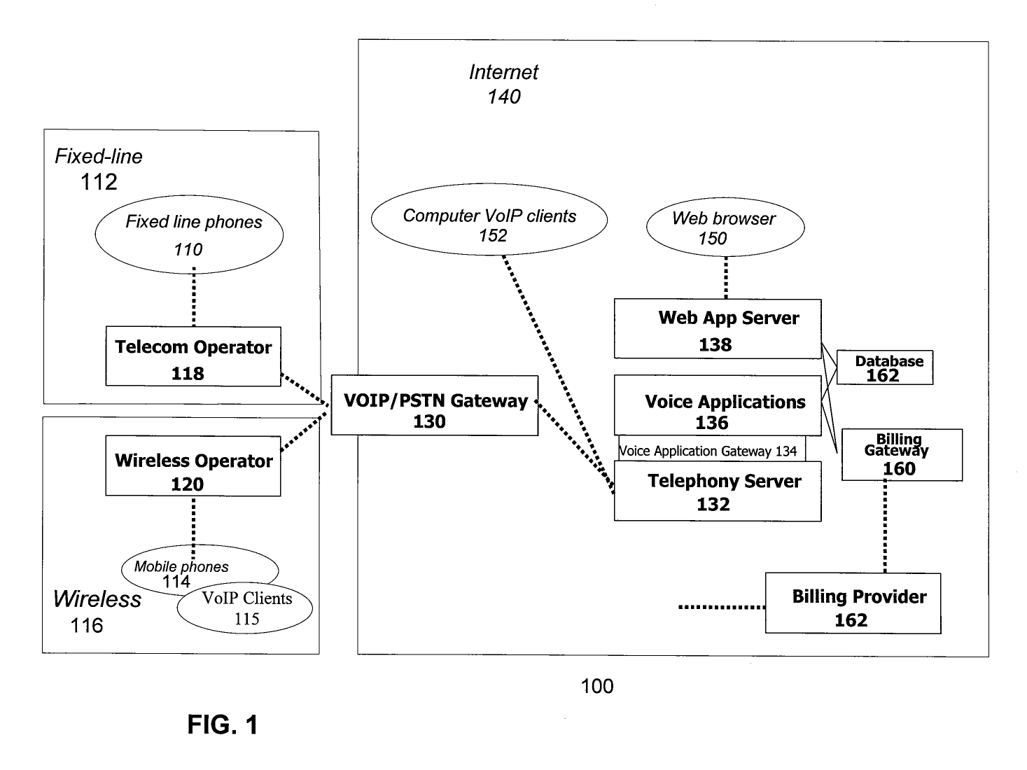

FIG. 1 is functional block diagram illustrating the primary functional elements of a system 100 that may be used to implement an embodiment of the present invention. As shown in the figure, voice messages or other multimedia content may be input to system 100 using a fixed line device (such as a standard telephone 110) operating over a fixed or wireline network 112, or using a mobile phone 114 operating over a wireless network 116. In the case of a fixed line network, a Telecom Operator 118 (e.g., a network operator of PSTN or legacy telephone networks and service) will receive the dialed number and process that data to permit connection to the desired end-point. Similarly, in the case of a wireless network, a Wireless Operator 120 (e.g., a network carrier or operator of wireless telephone networks and service) will perform the same or similar function.

The telephony network (either fixed line or wireless) is coupled to the Internet 140 using a VoIP/PSTN Gateway 130. Gateway 130 is a component that is typically managed by a 3rd party provider such as Level3™ or Global Crossing™, for example. Its primary function is to handle communication and data exchange between the VoIP network and the PSTN network (where the VoIP network generally refers to call sessions running over the Internet Protocol (IP) domain and processed by Internet components, and the PSTN network generally refers to call sessions running over the traditional legacy carrier networks, circuit switched and mobile phone networks, and typically connects to hardware interfaces such as fixed line and mobile phone devices).

Gateway 130 is coupled to and configured to exchange data with Telephony Server 132. Telephony Server 132 performs functions that enable audio data to be transported between the packet-switched (IP) and circuit-switched networks, such as data formatting, low level call control, assembly of IP packets into audio streams, encoding and decoding of audio data according to a set of codec and compression algorithms, negotiating handoff of call sessions with interconnected components such as VoIP/PSTN Gateway 130, and relaying commands and connections from Voice Application Gateway 134. Note that Telephony Server 132 may be implemented as a cluster of multiple physical server devices in order to distribute its load. In that case, a load balancing component would be placed between the cluster of Telephony Servers and the connection to the Internet.

Voice Application Gateway 134 couples Telephony Server 132 to Voice Applications element 136 and implements a control protocol between Voice Applications element 136 and Telephony Server 132. Voice Application Gateway 134 may be used to present an abstraction of the control functions for a lower level telephony handling layer for use by the application executing as part of Voice Applications element 136. In this sense, it may present an interface or set of interfaces for use by applications to enable those applications to access and control aspects of the Telephony Server functions (such as application programming interfaces).

Voice Applications element 136 broadly represents applications and functions that implement certain of the basis features and services of the present invention. Voice Applications element 136 may include a set of instructions executed by a processing element, a state machine, or other form of instructions or commands that may be used to implement the processes or functions of the invention. This may include algorithms, heuristics, and/or data processing capabilities to implement the voice call and/or VoIP functions used in the services and features of the present invention. Voice Applications element 136 may also be used to implement certain processes of the current invention that pertain to the user experience (e.g., presentation of the appropriate user interface), provide access to application programming interfaces (APIs) used to access other elements or components of the overall system, interface with application state data, or provide billing and/or other functions or services of the overall system. Note that Voice Application element 136 and Web Application Server 138 (to be described) may share an object, memory and/or processor space (i.e. they may reside in the same logical processor space). Note also that in addition to Voice Application element 136, certain aspects of the present invention may reside in other of the functional components described (e.g., Web Application Server 138 or Voice Application Gateway 134), and that in order to make the inventive system, apparatus and methods operate and scale in a desirable manner, the components may be combined or inter-connected with other interfaces or features.

Web Application Server 138 represents an element that functions to handle requests from web browser clients 150, where such clients may be applications executing on a computing device (e.g., desktop or laptop computer) connected to the Internet. Web Application Server 138 performs processing for handling HTTP requests as well as application logic to support the functions of the present invention. Web Application Server 138 may be configured to provide user interfaces (e.g. via HTML) and application state data (e.g. via XML) to user agents (such as browser 150) over the Internet or other IP connection. In some cases, computer based VoIP Clients 152 may connect to Web Application Server 138 directly to retrieve user interface or application state information.

Billing Gateway 160 is an element that may be used as an intermediary between the application components (i.e., Voice Applications element 136 and Web Application Server 138) and a variety of 3^{rd} party Billing Providers 162. This element assists in the billing function by providing data capture and routing of billing related data that is generated when users access certain of the functions and services enabled by the present invention. Similarly, Billing Provider element 162 represents possible 3^{rd} party billing providers (e.g., credit card processing, PayPal™, premium SMS and integration with mobile or fixed line operator billing systems).

Database 162 represents a data storage element that is configured to handle data storage requirements of the present invention, possibly including state data which may be utilized in implementation or other functions pertaining to the invention.

As indicated, the functions and services of the present invention may be accessed and/or controlled by users via several different types of devices, where those devices may be executing one or more of several types of client applications. Such devices include fixed-line phones 110 (where access and control may be provided by audio input and/or DTMF signals generated by the phone keypad), mobile or smart phones 114 executing a mobile browser or mobile VoIP client 115 (a data client in a mobile device which connects over a wireless network but communicates via IP and is capable of making a VoIP connection), or a desktop or laptop computer executing a web browser application 150 or VoIP client application 152, among others. In general, Web Browser 150 refers to a user agent capable of communicating using IP over the Internet and controlled by a user, including for example, agents like Internet Explorer, Mozilla, some types of Internet-connected mobile devices and automated processes such as web spiders. In general, VoIP Clients 152 refers to a user agent capable of making a VoIP protocol connection, including for example, Skype™, Google Talk™ and other computer applications as well as web-embeddable VoIP clients.

In order to illustrate the typical operation and interactions between the system components, and to explain the mechanisms and procedures that may be used to interface between those components when handling calls and providing the inventive services, examples of how specific calling functions may be implemented will be provided. For a computer VoIP call session initiated by a VoIP client executing on a desktop or laptop computer, a VoIP client 152 connects to Telephony Server 132 over the Internet, creating a call session. Data is encoded according to a VoIP protocol such as SIP, H323 or other suitable protocol, and audio is encoded with a codec such as GSM or other suitable codec. Telephony Server 132 registers this connection with Voice Application element 136 using Voice Application Gateway 134 to control the connection. Voice Application element 136 executes one or more processes to handle the logical processing of the call session, for example to access database 162 or the shared object model for state information, or use billing gateway 160 to process payment events tied to provision of the service.

For a fixed line phone call session, the call originates from the user's phone device 110, and uses Telecom Operator's 118 network to connect to VoIP/PSTN Gateway 130. Gateway 130 executes one or more processes to translate the call into a packetized VoIP session, and relays this to Telephony Server 132. From that point on, the interconnection is handled in the same manner as the computer VoIP call session described above.

For a dial-out connection, a call session may originate from Web Application Server 138. This component uses the shared object model to initiate a request to Telephony Server 132 using the Voice Application Gateway 134 as a control mechanism, passing the destination IP address, URL, SIP Address, phone number or other identifying destination address. Based on the nature of this address, Telephony Server 132 establishes a call session with a VoIP client 152 across the Internet, or with VoIP/PSTN Gateway 130. This session uses a VoIP protocol such as SIP, H323 or other suitable protocol, and audio is encoded with a codec such as GSM or other suitable codec. If used, VoIP/PSTN Gateway 130 converts this VoIP session into a PSTN connection and brokers with the appropriate Telecom Operator 118 to pass the session along and terminate the call. Note that in the case of a mobile VoIP client 115 connected over a Wireless Operator 120 network, the path established is from Telephony Server 132 over the Internet to Wireless Operator 120 directly, who then subsequently proxies the IP data transmission using their own mechanisms. For a Web Browser 150 initiated session, the browser or other user agent connects over the Internet using HTTP over IP to Web Application Server 138, which in turn generates a response in a format such as HTML or XML for display and navigation using the browser.

As the inventors have recognized, it is currently difficult for groups of users who are distributed and connected by a network such as the Internet to communicate by audio and/or video as a group or virtual community, using their Internet and/or phone systems to participate in those communications. As a result, community participation and exchange of information is limited and prevents development of a cohesive and integrated community. The present invention is designed to provide a useful, convenient and flexible way for users across the Internet to create and share audio content in a forum or bulletin board format. This can facilitate group communications and interactions, and lead to the execution of collaborative tasks for users connecting via the Internet and fixed line or mobile phones.

As noted, the present invention is a client-server based group audio messaging system which permits group communications in a forum or bulletin board format. In this manner the invention provides a common forum that may be accessed by multiple group members to post, retrieve, comment upon or otherwise interact with voice or audio content. The features, advantages, and attributes of the inventive system include, but are not limited to the following:
A user can create a private forum, and limit access by identifying group members who will have access to that forum, or allow anyone from the public to have access;
A user can leave a message or post audio content that is accessible to all users of a forum;
A user can delete a message or audio content once they have heard it, without affecting the ability of other users to access the deleted content. This is important because each user has their own view of the stored content that will never be affected by the actions of others. This can be accomplished via the use of queries to a database, “cookies”, and/or various other methodologies that allow the system to maintain state.
A forum can be accessed from the Internet (via a web browser or VoIP enabled client) or via a regular phone (i.e., fixed line) or mobile phone. The inventive system can be configured to provide both a unique URL and phone number access for each forum created, thereby enabling users to listen to messages and post new messages or content by web browser or phone; and
The inventive system is able to protect the privacy of the participants, unlike phone voicemail (which stores the caller id of the caller and is associated with a person's personal phone number).

In implementing the services and functions of the present invention, the functional elements of the inventive system may include, but are not limited to:
A routing and transcoding component configured to process audio data and transcode the audio from various phone or Internet forms into a digital form to enable it to be stored for later use;
A data storage component configured to index and store audio messages or content in association with the forum to which they belong;
A web user interface which permits a user to establish an account, create a forum of their own, chose a existing forum, listen to messages or leave messages for any forum they are authorized to have access to;
A phone number assignment element which assigns phone numbers and/or phone number access codes for each forum created by the inventive system;
A phone gateway which interfaces with a PSTN provider to route incoming calls to a logical routine to allow the caller to be authenticated, chose a forum and post audio messages or content to a forum they have access to; and
Relevant interconnection elements to enable clients such as instant messaging, xhtml or VoIP softphone clients to connect, allowing the users of such to authenticate, choose message boards and leave messages or content.

As will be described in greater detail, in a typical situation, a user of the inventive system may perform the following functions, among others:
Create a forum:
The user establishes a user account on the system through the web interface or fixed-line or mobile phone;
The system creates a forum object and assigns a phone number; and
The user adds friends and associates to the forum object, by specifying phone numbers, email addresses, or other identifiers.
Listen to messages or retrieve audio/video content:
When a user has access to a forum, they are able to access it in various ways—the user may access the forum object by name, or it may be presented to them based on their user credentials. The access method may be via web interface, fixed-line or mobile phone interface, SMS, or other communications protocols;
The user is able to listen to new and old messages or content, and delete messages or content; and
The user is able to download or send content from the forum to their email address, mobile device, or to other users' forums or devices.
Note that each user's view into the forum object is individualized; that is, what they see as new, old or deleted may be tailored for their view of the system and distinct from another person's view.
Post a message, audio, or other content:
The user accesses the forum object by phone or web in a similar way to that for listening to messages;
The user speaks a command or presses a key indicating they would like to leave a message;
The system prompts the user to choose from a list of pre-recorded audio or to skip this step to record their own audio. If the user chooses to attach pre-recorded audio to their message, then they will be given a simple interface that allows them to browse, search, and discover content that is suitable to his/her present needs;
The system records the user's audio and/or prompts the user to submit other content;
The system prompts the user to choose from one or more pre-determined lists of recipients or to enter a unique forum ID associated with another forum member;
The system verifies the recipient(s) and adds the content to the forum; and
Each of the recipients, other forum members, may be notified that new messages are available.
Note that the notification process may take place in accordance with each user's own individual preferences and may be delivered by email, SMS, IM, phone call or another means.
   Discover like-minded virtual community members:
   The user accesses the forum object by phone or web in a similar way to that for listening to messages;
   The user speaks a command or presses a key indicating they would like to interact with users within the virtual community that the user has never interacted with before;
   The system automatically retrieves as much information as it can about the user, while prompting the user to provide additional information that the system requires to make a useful determination of which forum to connect to the user to; and
   The system connects the user to a series of forums that the user can navigate and interact with.

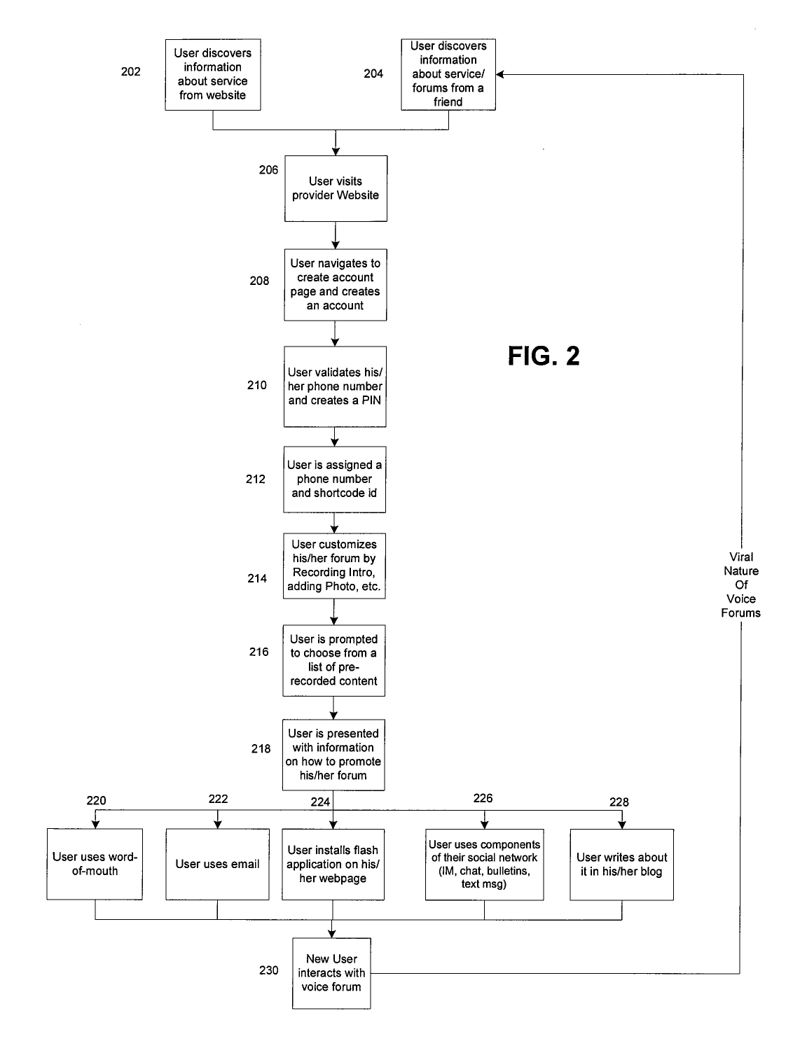

A user's interaction with the services and functions of the present invention will typically involve creating their own voice forum, accessing their own previously created forum, or accessing the voice forum of another person. FIG. 2 is a flowchart illustrating an example process to enable a user to create a voice forum in accordance with an embodiment of the present invention.

As shown in FIG. 2, the process typically begins with a prospective user of the voice forum service discovering information about the service from a web-site, either that of the service provider (for example, www.Snapvine.com, the assignee of the present invention) or another source (stage 202). Possible other sources include, but are not limited to, a satellite or embedded application that appears on another person's social networking web-site, e.g., Myspace, tagged, classmates.com, or a person's web log (blog). Other possible sources include text messages written by the owner of a blog or social networking profile to his/her friends/readers/fans, a text message sent to a person's mobile device, a phone call initiated by the service provider to the potential new user on behalf of a registered user of the service, etc.

Similarly a potential new user may be informed about the service by a friend or acquaintance (stage 204). A difference between the discovery process depicted in stages 202 and 204 is that with regards to stage 204, the intent for the recipient of the information or visitor is to “Leave Me a Comment”, by adding to the audio, text, and other media associated with the sender's account. This is important in the sense that there is a completely different value proposition for the visitor in this scenario. For instance, the reason why they are going to act is based upon the desire to be included within the community vs. starting their own community centered around their own interests.

In either case, the new user or visitor then accesses or visits the provider web-site (e.g., www.Snapvine.com) or other system interface (stage 206). Access to the web-site or system interface may be obtained via one of several ways; these include using a web browser or client application executing on a computing device (such as a desktop or laptop computer), dialing a phone number that was presented in either stage 202 or 204, via WAP (wireless application protocol, a mobile internet interface), via a SMS/MMS message, or other suitable method. After accessing the web-site or system interface, the user navigates to the “create account” or equivalent page and initiates the process of creating a service account (stage 208). Creating an account typically requires the user to enter certain identification and security data, along with profile information that may be used by the service for purposes of personalization or demographic based marketing. Such data may include the following information: 1) Name, 2) nickname, 3) email address, 4) phone number, 5) password, 6) Country of Origin, 7) timezone, 8) age, 9) gender, 10) location (city, state, region, postal code), and 11) reason for signing up. In addition, other demographic or personal profile data may be gathered at the time of signup, including hobbies, lifestyle, interests, favorites, websites they visit, level of schooling, etc.

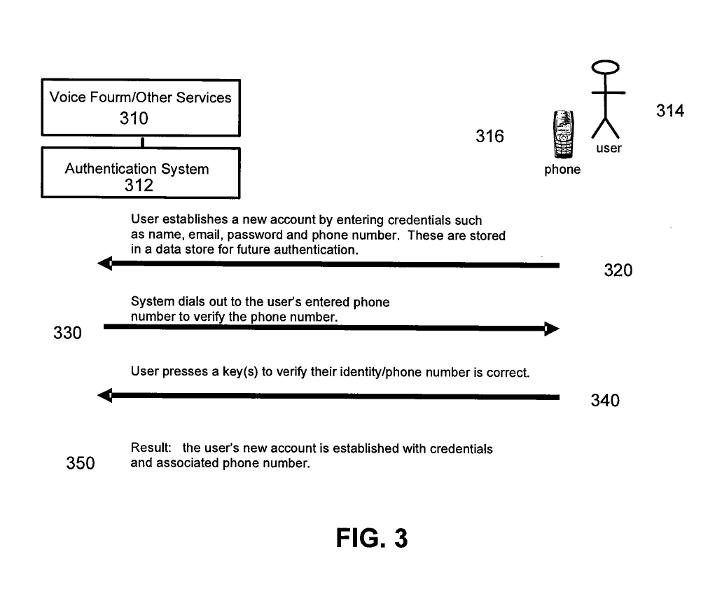

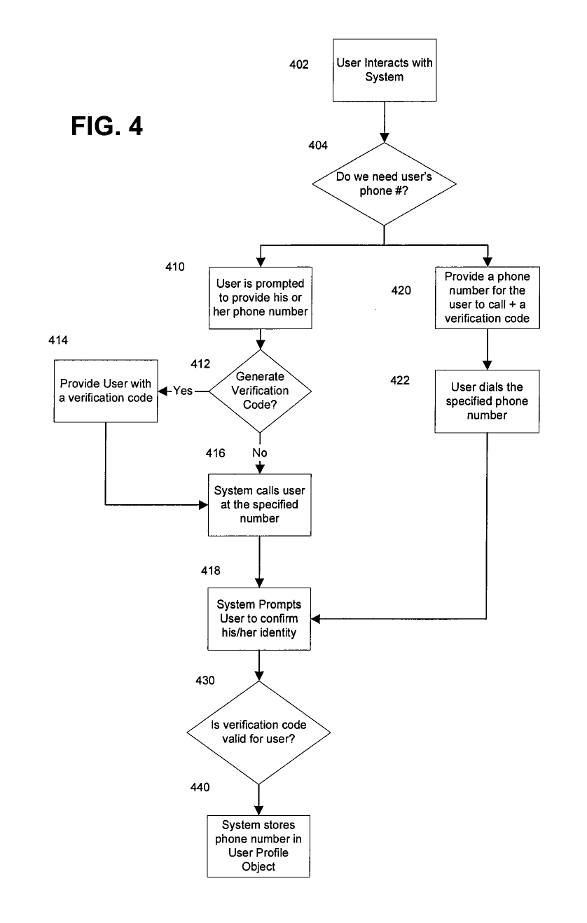

In order to create an account, the user must verify that they are who they purport to be (stage 210). This may be accomplished by one or more of various possible methods. One such method is email verification. This involves not letting the user have access to advanced features until they follow a link that has been emailed to the email address that they provided. The email could also include a shared secret that the user must enter within some period of time. Another form of validation is based upon the phone number that was entered. One way of implementing the verification process is by dialing out to the user's phone number and prompting them to verify that they were the person who created the new account. Another way of doing this is by providing a number that the new user must call, and then requiring them to enter a series of digits from their device. In this verification method, the number the new user dials in from must match the number that they entered during the registration process. Yet another verification method is via mobile messaging. The system could send a message to the person's mobile device that the user must reply to in order to obtain access to additional advanced features. The registration and verification processes will be described in greater detail with reference to FIGS. 3 and 4.

Once the user is validated, they are assigned a phone number to share with their friends and an identification string/number (stage 212). The identification string/number may be a short code or alphanumeric string and can be used by others to access the user's forum. The phone number is associated with a voice forum application accessible by that number. The short code is used to identify a particular voice forum (that of the user). A URL may also be assigned to the forum to permit web based access to the forum and its contents. Note that if the new user had left messages or content for registered users before creating an account of their own, then at the time that they create an account, their friends may be given information on how to direct-dial them. A direct-dial number is a unique phone number that the friend can use to be connected directly to the user's forum without requiring the friend to enter the identification string/number. Note also that the assigned phone number may be shared by more than one user of the voice forum or other service, and whether shared or not, may provide different options or services depending upon the person dialing the number (e.g., based on the caller ID of the person who dials the number).

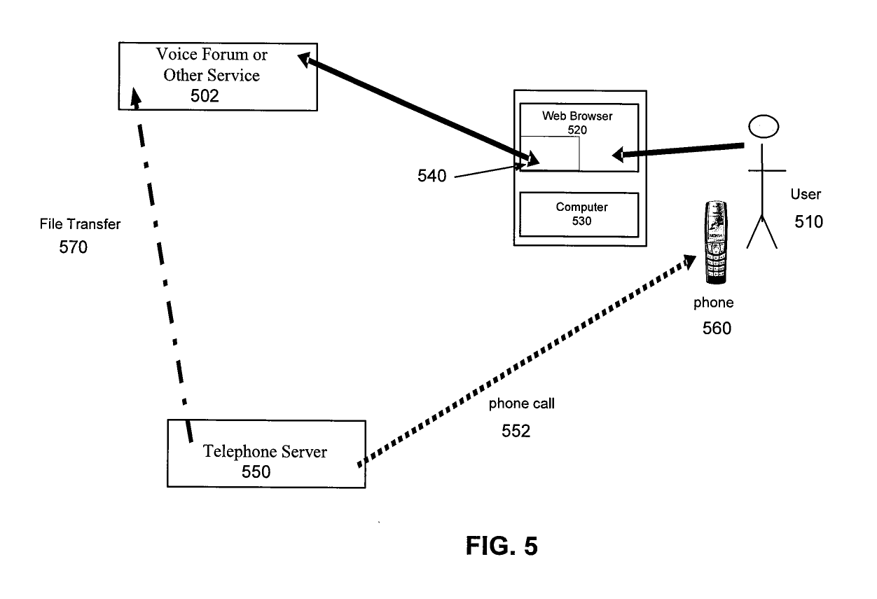

The user then may provide content for the forum to customize or personalize their forum (stage 214). The content may be audio content such as an introduction, audio content for purposes of initiating a discussion, and if desired, image, video, or other content that may be accessed via the relevant interface of the visitor. A suitable method or process for providing the audio, video, or multi-media content will be described with reference to FIG. 5. The user may also be provided with an opportunity to select from a list of pre-recorded or previously selected content (stage 216), where that content may be an audio file or other form of content (image, video, text, etc.). If the user chooses to use content created by another source (i.e., other than by themselves), a billing event can be triggered through Billing Gateway 160 that will charge the user for the content.

Next, the user may be presented with information regarding how to promote their forum, such as how to distribute information to enable others to access and contribute to the forum (stage 218). These promotional activities may be accomplished via one or more communication methods, including, but not limited to, word-of-mouth (stage 220), email (stage 222), instant messaging, other forums or bulletin boards, text messaging (stage 226), a web log (stage 228), or installation of an application on the user's web page (e.g., a Flash application, stage 224). Such an application may be activated by a visitor to the web page and upon activation, initiate a connection to the user's voice forum. The connection, for instance, can be achieved via a web service (XML-based) API that allows the application to retrieve data related to the forum, based upon the access rights of the visitor.

After creation of the voice forum, new users (other than the creator of the forum) interact with the forum (stage 230), continuing the growth of the community that is interacting and communicating with each other (as exemplified by the label “Viral Nature of Voice Forum”).

FIG. 3 illustrates a registration process that may be utilized by a user as part of creating a voice forum in accordance with an embodiment of the present invention. FIG. 4 illustrates an authentication or verification process that may be utilized by a user as part of interacting with a voice forum in accordance with an embodiment of the present invention. Additional description of the registration process, authentication process, and the relative benefits and advantages of those processes may be found in U.S. patent application No.______, entitled “Web Authorization by Automated Interactive Phone or VoIP Session”, filed Feb. 13, 2007, the contents of which is hereby incorporated by reference in its entirety.

As discussed with reference to FIG. 2, to create a voice forum, a user typically registers with a provider of the forum by navigating to a web-page, placing a call to an appropriate phone number, or executing a similar operation. Note that the registration process may be performed using a web browser executing on a computing device or mobile phone, by using a fixed line phone and entering voice commands (interpreted by an interactive voice response system, for example) and/or DTMF tones using the keypad, or via a VoIP client executing on a mobile phone or computing device, among other methods. As shown in FIG. 3, a possible registration process involves a user (element 314) establishing an account with a provider of the voice forum or other services (element 310) and may include providing a user name and password, billing information, and if required, a means for authenticating the user (such as the user's phone number) (stage 320). To verify that user 314 is the owner of that phone number, the authentication or verification system (element 312) may automatically dial out (stage 330) to the user's phone 316 and request that the user confirm their registration (for example, by pressing a key, entering a phone PIN, or speaking a phrase) (stage 340). After receipt and processing of the entered data, the new account is established and associated with the user's phone number (stage 350).

As part of a registration process and/or for subsequent attempts to access the established account/forum, a user may be required to execute an authentication or verification procedure, such as that illustrated in FIG. 4. Such an authentication procedure may include, for example, requiring a user to log into the forum or service website in a two-step process. Firstly, the user logs in with their usual credentials (i.e., those used to register the user and establish the account) as indicated by stage 402. If the credentials are correctly entered, the web site will then determine if user's phone number is needed for the authentication process (stage 404). If the phone number is needed, then the user is prompted to provide a phone number (stage 410) which is then stored for later access. The system then determines if a verification code is required by the authentication process (stage 412). If such a code is needed, then the user is provided with a unique verification code or string (stage 414). This verification code can be permanent or temporary. The verification code is associated with the user's phone number, creating a data-tuple stored in the system data storage.

The system then dials-out to the user at the phone number specified by the user, which is associated with the newly updated user account (stage 416). The dial out process may be implemented by the Web Application Server (element 138 of FIG. 1), which triggers an automatic phone call by accessing database 162 to retrieve the user's phone number, and utilizes a TDM, PSTN, VoIP or VoIP/PSTN network or connection as appropriate to connect to the user's phone.

If the system determines at stage 404 that the user's phone number is not needed for the authentication process, then the system may provide the user with a phone number to call and a verification code (stage 420). The user then dials the phone number provided (stage 422). After connection to the user (either via stage 416 or stage 422), the system prompts the user to confirm his/her identity (stage 418). The user verifies their identity by providing the verification code (if one is required), such as by pressing a key, entering their phone PIN or speaking a phrase. The system then determines if the entered code is correct (stage 430) by determining if the entered code is associated with the user. If the entered code is correct, then the system stores the phone number and verification results within the user profile data (stage 440). This means that the user has been verified and authenticated. Depending upon the level of authentication required by the system, this could be enough security to enable the caller to interact with a majority of the features offered by the system. If the entered verification code is incorrect, then control may be passed back to stage 418. If after several attempts the correct code has not been entered, then the user is not authenticated and an error message may be generated.

Note that all or a portion of the registration and/or verification process may be implemented by a user by means of a fixed line phone, mobile phone, or VoIP connection. Thus, although registration may be accomplished via one mode of communication (fixed line, mobile phone, etc.), the verification process or a subsequent transaction verification process may occur contemporaneously or at a later time, and may be accomplished using the same or a different communication mode than that used for the registration process.

Another mode of interaction between a user and the system is by the user sending a command to the system via a SMS message generated on the user's mobile phone or PDA, followed by the user receiving a numeric string generated by the system. The user then calls the system and confirms their identity by entering the string on the phone keypad (thereby generating DTMF codes).

In general, the alphanumeric verification code or string may be entered by the user using a phone keypad (thereby generating DTMF tones), voice commands (that may be interpreted by an interactive voice response system), SMS text message, or other similar means. In addition, the alphanumeric verification code or string may be provided to the user by the system by means of a SMS message, email, voicemail message, or other communications means. The verification data may be provided by the user in response to receiving a phone call or message from the system or the user may provide the verification data by placing a call to the system followed by entering data using the keypad, sending a text message or speaking a phrase.

Note that the described registration and authentication processes provide the following features and advantages:
If a user's textual credentials are stolen in a phishing or social engineering attack, the thief will not be able to log into the website unless they are in physical possession of the user's actual phone;
Even if the thief knew the user's phone number, it would not help them perform an authentication since they would not be able to answer the phone at the time of authentication in order to finalize the log in process;
In situations where credentials are stolen, the thieves and victims are usually not in close proximity and thus it is highly unlikely that the thief would also have access to the user's physical phone;
The described process requires no additional cost of deployment because no special hardware is needed; and
Many people carry around their mobile phone wherever they go and thus in that case, the process presents only minimal additional user burden.

As a result, the described registration and authentication processes provide advantages over other methods of providing similar registration and/or authentication services for conducting transactions. These include, but are not limited to:
Enhanced security—because it is nearly impossible for a potential thief to steal a person's physical phone, even if the thief is able to obtain a user's password by use of social engineering, phishing, guessing or any other technique, they will not be able to gain access to the user's account without physical access to the user's phone which they will be unlikely to gain possession of;
Less user burden—compared to requiring strong passwords or cumbersome biometrics procedures, the described method adds very little burden to the end user of existing account registration or login processes; and
Faster detection of phishing—users who visit a phishing site and enter their text credentials will know immediately, because the final step of the login process (dialing the user's phone) will be difficult for a phishing attack to replicate, since the phishing attacker will likely not know the user's phone number. Thus, users will be able to recognize and detect improper phishing attempts faster.

As noted, after registration, a user may provide content for their forum. The content may be audio content such as an introduction, audio content for purposes of initiating a discussion, and if desired image, video, or other content that may be accessed via the web-site URL or any other system interface. A suitable method or process for providing the audio content will be described with reference to FIG. 5, which illustrates a process for providing content to a web application using a phone as the input device. This process may be utilized as part of the present invention as a means of providing the content for a voice forum, and may be used by both the forum creator and by visitors to the forum who wish to contribute their own content or comments. The process or method to be described can be used by a computer user as long as they are near a phone (fixed-line or mobile), requires no configuration or setup, and can be used with any web application (i.e., not just the voice forum of the present invention).

As shown in FIG. 5, the process of providing content to the voice forum or other service 502 by a user 510 is initiated by accessing a designated web-site associated with the forum or service 502, using web browser 520 or a similar application executing on a computing device 530. User 510 is presented with a suitable user interface to enable the initiation of an audio capture session. For example, an html (or another markup language) or JavaScript plug-in (element 540) may be used to present a pop-up dialogue to user 510. User 510 is presented with a confirmation message that will be recorded by dialing out to a phone (or phone simulator). They may be presented with a list of known phone numbers associated with the user, or asked to input a phone number (or SIP or other voice-capable address). User then activates a “record now” command, or other suitable means of activating the recording function.

The user interface or other means of initiating the recording function results in communication with Telephone Server 550 to start the audio recording session. Telephone Server 550 then initiates an interactive call session 552 (depicted as “phone call” in the figure) by opening up a VoIP communication channel with a VoIP/PSTN provider in order to reach the user via phone 560, or by communicating directly with a voice capable device or software with a VoIP connection.

Once User 510 answers the call, an interactive session may proceed as follows:
A computer voice or recording asks the user to record their audio;
The user speaks into the phone, or plays a sound over the connection;
The Telephony Server records the audio content and stores it on the server for use by the application associated with the call session; and
The call ends.
   The result is that the voice or audio content has been captured and is ready for use by the voice forums or other application (upon transfer to that service, as depicted in stage 570). User 510 may be notified that the recording is complete by showing them a status message using the web user interface. The interface may include a button or other icon that may be activated to hear the newly recorded audio as well as to record again (re-record or add other content). The voice forum or other application providing the audio-capture feature is notified of the completion of the recording session, and the audio or a link to the audio may be transferred to that application (as depicted in stage 570).

Although the audio content recording process has been described with reference to a fixed line or mobile phone, possible variations to the above components and/or process include, but are not limited to:
Instead of a telephone and phone call, a connection is established to the user using another audio-capable device;
Instead of a telephone and phone call, a connection is established to the user via a software phone simulator (softphone, IM, or VoIP phone) or IP based phone integrated with a mobile wireless device;
Instead of recording one user, the system may call a set of multiple users and merge or sequence the individual users' recorded audio content into a single file; and
Instead of automatically dialing out to the user to record, the user dials into the server using a phone to record the audio content.

Note that the recording process can be embedded into another 3rd party service by allowing that service to add HTML and/or JavaScript to their website and in this case the resulting audio is transferred from the dial-out recorder service provider by ftp, web api, http or by assigning a URL to the audio content.

The recording process described provides many advantages over other means of providing similar services and functionality. These advantages include that the process may be used with any web application that is properly configured to record and/or utilize user audio content without requiring a browser-plug-in, operating system extension or software installation. Existing methods require such and also that the user must have or install a microphone and configure the recording input levels. These steps are too difficult or tedious for most users, thus hampering the usage of the device and the ability to record and utilize audio content. Another advantage of the described method is that it can process the actions (recording and storing audio) on behalf of 3rd party web sites, thus making it easier for a service provider to adopt this feature as part of their own web application or service.

Note that instead of, or in addition to, providing voice or audio content to a voice forum or other application by recording audio input from a user via the user's phone, a user (i.e., the creator of a forum or visitor to a forum) may choose to leave (i.e., post) one or more pre-recorded messages or comments. That is, a user may select audio content for posting to, or incorporation with, a voice forum in one embodiment of the present invention.

As will be described, a user may choose to select one or more pre-recorded messages, comments, or other audio content for posting to a voice forum. Note that the pre-recorded message, comment, or other audio content (e.g, a sound effect, snippet of a song, etc.) may be selected and incorporated using a user interface accessed via a web-page, and therefore does not require use of a microphone or other audio input device. However, note that control of the process may also be accomplished via inputs to a fixed line or mobile phone keypad, or via voice commands interpreted by an interactive voice response (IVR) system. Further, a user may desire to add a short personal message to the selected audio content, in which case a telephone or other audio input device would be used.

The inventive system and process for selecting and posting audio content to a voice forum may provide, among others, the following functions and attributes:
A system and process by which content and interactive features can be selected using a web interface, mobile device interface (such as WAP), SMS shortcodes, keypad DTMF tones, or an interactive phone call (IVR);
A mechanism for a sender to schedule the delivery of the content and/or interactive payload (by specifying time, mode of delivery) to the forum or other recipient instantly or at a time in the future;
The content payload may be one or more of the following examples
   a short audio clip chosen from an online catalog of choices;
   a set of clips assembled at the time of delivery according to specified parameters; or
   a recording or set of recordings created by the sender at the time of message creating, time of sending or sometime in the past.

The posted content (or interactive payload) may include a set of possible actions, interactions, or executable functions for the recipient that include, but are not limited to:
Answering a set of pre-formed questions by key press or voice;
Responding to the voice message by replying with another message;
Replying to the message by voice, where the reply is delivered by any chosen means such as voicemail, email, MMS or other means;
Instantly joining in a telephone call with the sender;
Instantly joining in a live telephone call with the other recipients;
Being redirected to an offline voice forum wherein the user can leave messages for a group of people or listen to other's comments; or
Playing an interactive audio game.

A typical process flow for selecting and distributing such a payload may include the following stages:

Visitor calls phone number and is connected to a User's forum;

Visitor is prompted to listen or leave a voice comment;

Visitor chooses to leave a voice comment;

Visitor is prompted to record a comment or choose from a set of pre-recorded messages;

Visitor chooses pre-recorded messages and is then presented with a menu of messages;

Visitor chooses pre-recorded message #2 under a selected category;

Visitor is prompted to record their name;

Visitor is prompted to record a short message (e.g., 30 secs or less);

Visitor records short message;

Visitor is asked whether message should be played before or after pre-recorded message;

Visitor is asked to confirm sending message; and

Visitor/system sends message.

Possible variations to the above include, but are not limited to:

Visitor sends the same message to more than one person, for example, could choose to send to all of his/her friends;

Recipients have the message sent to their mobile device instead or in addition to their forum;

Visitor specifies whether or not the message is public or private;

Visitor enters this flow after using a search/browse/discovery feature; or

Recipients have an SMS sent to their device and then hear the message after dialing-in and authenticating.

As noted, the selection of content for posting to the voice forum may be accessed via a phone, SMS interface, IM client, and/or a web-page over the Internet. Further, the described system and methods do not require any particular new hardware deployment on the telephony network, handset or internet client as with other interactive messaging services such as MMS based services, etc. The system and methods also provide both the sender and recipient a choice of means to access the service, either via fixed line, mobile communications or via the Internet. Further, the selection and/or delivery of content can be either free or have a specified cost to the sender. The system, upon selection and/or delivery could initiate a transaction by sending a request to the Billing Gateway (160). Depending upon the result of the Billing Gateway's attempts to charge the sender or the recipient, the system can make a determination as to whether to deliver the content and/or notify the sender.

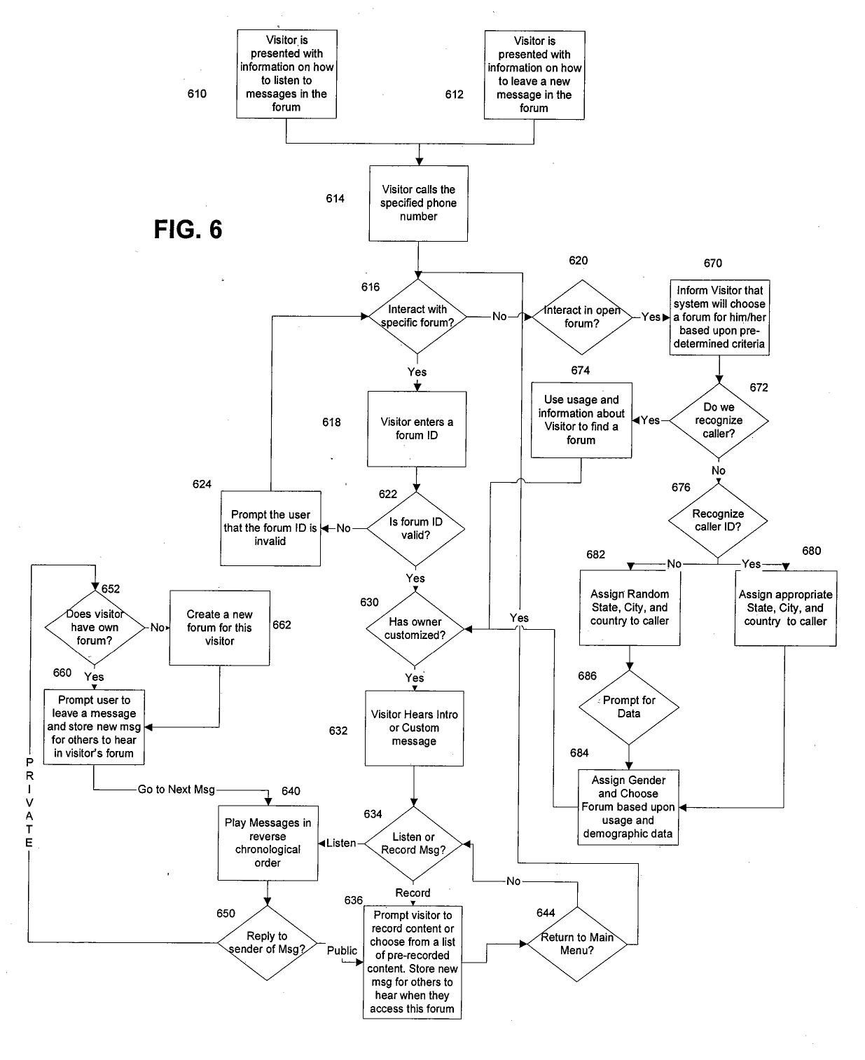

FIG. 6 is a flowchart illustrating an example of how a visitor to a voice forum might interact with that forum in accordance with an embodiment of the present invention. It is noted that a visitor may discover the voice forum or other service via several channels. One way is via the provider web-site (e.g., www.snapvine.com, the assignee of the present invention). Another is via a satellite or embedded application that appears on some other person's social networking website or web log (blog). Another way is via text messages that are written by the owner of a blog or social networking profile to his/her friends/readers/fans (visitors). Yet another is via a text message sent to the visitor's mobile device, via a phone call sent by the service provider to the visitor on behalf of a registered user, etc. In all of these cases, the intent is to encourage the recipient or visitor to “Leave a Message” for the owner of the forum account, thereby adding to the audio, text, and other media associated with the owner's forum.

As shown at stage 610, upon accessing the web-site, the visitor is presented with information regarding how to listen to messages previously posted to the forum. In addition, the visitor may be presented with information regarding how to leave a message or audio content for the forum (stage 612).

The visitor is then able to interact with the system. Note that interaction can occur via multiple channels. The visitor can dial a shared phone number that provides access to the voice forum or service (stage 614). This number can be a direct-access number or be accompanied by a short code or unique alpha-numeric ID. Similarly, the visitor could interact with an application that is embedded within a webpage or connected application. The visitor could also interact with the system via a messaging system capable of providing audio, video, or text. The visitor could also use a short-messaging system to send queries to the system from their mobile device.

Note that if dialing into a direct-dial number, the visitor may automatically be directed to a specific voice forum associated with that number. In that case, control is passed to stage 630. If the visitor did not dial such a number, they may be queried as to whether they desire to interact with a specific forum (stage 616). If the visitor responds in the affirmative, then they will be asked to provide a specific forum ID for the forum that they want to interact with (stage 618). If the visitor doesn't know or specify a forum which he/she wants access to at stage 616, then they can be directed to an Open Forum (stage 620).

If the visitor enters a forum ID number at stage 616, then the forum ID number is checked to determine if it is valid (stage 622). If valid, then control is passed to stage 630. If not valid, then control is passed to stage 624 where the visitor is notified that the forum ID is invalid, and control is returned to stage 616.

Next, the process determines if the creator of the forum has customized the forum (stage 630). If the forum creator has customized the forum, then the visitor may be played an introduction or custom message (stage 632). Further, if the system recognizes that the visitor can receive photos on their mobile or other device, the process may include providing the visitor a photo on their device or within an embedded application.

After hearing the customized content, or if the creator of the forum has not customized the forum, then control is passed to stage 634. The visitor is then offered the opportunity to either listen to or interact with existing messages/content that have been associated with the forum or instead to record/submit new content that can be associated with the forum (stage 634). If the visitor wishes to record content or select from a list of pre-recorded or previously selected content, then control is passed to stage 636. If the visitor wishes to listen to previously recorded content, then control is passed to stage 640.

If the visitor desires to record or submit content for placement on the forum, then they will be prompted to record/submit new content or select previously recorded or selected content that can be associated with the forum (stage 636). Note that if the user chooses to use content created by another source (i.e., other than by themselves), a billing event can be triggered through Billing Gateway 160 that will charge the user for the content. After recording (which may be accomplished using the process described with reference to FIG. 5, for example) or selecting content, the content is submitted for posting on the forum and control is passed to stage 644.

The visitor may then be queried as to whether they desire to return to the main menu (for example by returning control to stage 616), or if they desire to listen to or record content for the forum (stage 634).

If the visitor desires to listen to previously posted content, then the content that has been associated with the forum is sent/provided to the visitor in reverse chronological order (stage 640). Note that the visitor can request additional content or the system can send each subsequent content source automatically to the visitor.

After each piece of content is shared with the visitor, the visitor is given the opportunity to reply to the creator of the content (stage 650). The “reply” can be in multiple forms: 1) via a message that is associated with the creator's forum, 2) via a message that is sent directly to the creator's mobile phone (dial-out), 3) via an email that contains media/text links, 4) via a text message that contains media/text links, or 5) via an embedded application that alerts the creator (and others if desired) that new content is available.

At this point, the process may determine if the person who left the content has their own forum (stage 652). If they do, then control is passed to stage 660. If they don't, then control is passed to stage 662 to enable the system to create a forum on behalf of the visitor that had created or left the original message, after which control is passed to stage 660. At stage 660, the visitor is prompted to record a message or content and have it sent to the creator of the previous content piece. Once the visitor records the content, he/she can determine whether to mark the comment as private. Once the content has been posted, control is returned to stage 640 for playback of the next message or content.

Returning to stage 620, if the visitor wishes to interact with an open forum, then control is passed to stage 670. At this stage, the system informs the visitor that it will attempt to determine a forum for the visitor to interact with (stage 670). If the visitor is recognized as having their own previously established forum (stage 672), then control is passed to stage 674 where the system uses available information that the system has for the visitor to determine which forum the visitor will interact with. After determining that forum, control is passed to the stage 630 part of the process that corresponds to that forum.

If the visitor does not have their own forum, then the system attempts to determine if the visitor has previously interacted with the system, such as by dialing-in or generating content for another forum (stage 676). If the visitor has previously interacted with the system, then control is passed to stages 680 and 684, where based upon the visitor's demographic data and recent activity, and data recorded in aggregate by the system, a forum is assigned for the visitor to interact with.

If the visitor is not recognized as having previously interacted with the system, then control is passed to stages 682 and 686, where through the use of dynamic algorithms and usage data recorded in aggregate by the system, the system determines a forum for the visitor to interact with. This can be based upon the country, region, state, area code, city, gender, etc. that the system has gathered information on, or about which forums are popular or not getting enough attention. If additional information is required by the system to better complete the assignment process, then the visitor may be prompted for that information (stage 686), such as gender, hobbies, interests, lifestyle, etc. After receiving the requested data, the system passes control to stage 684 where a forum is selected for the visitor and then to the stage 630 part of the process that corresponds to that forum.

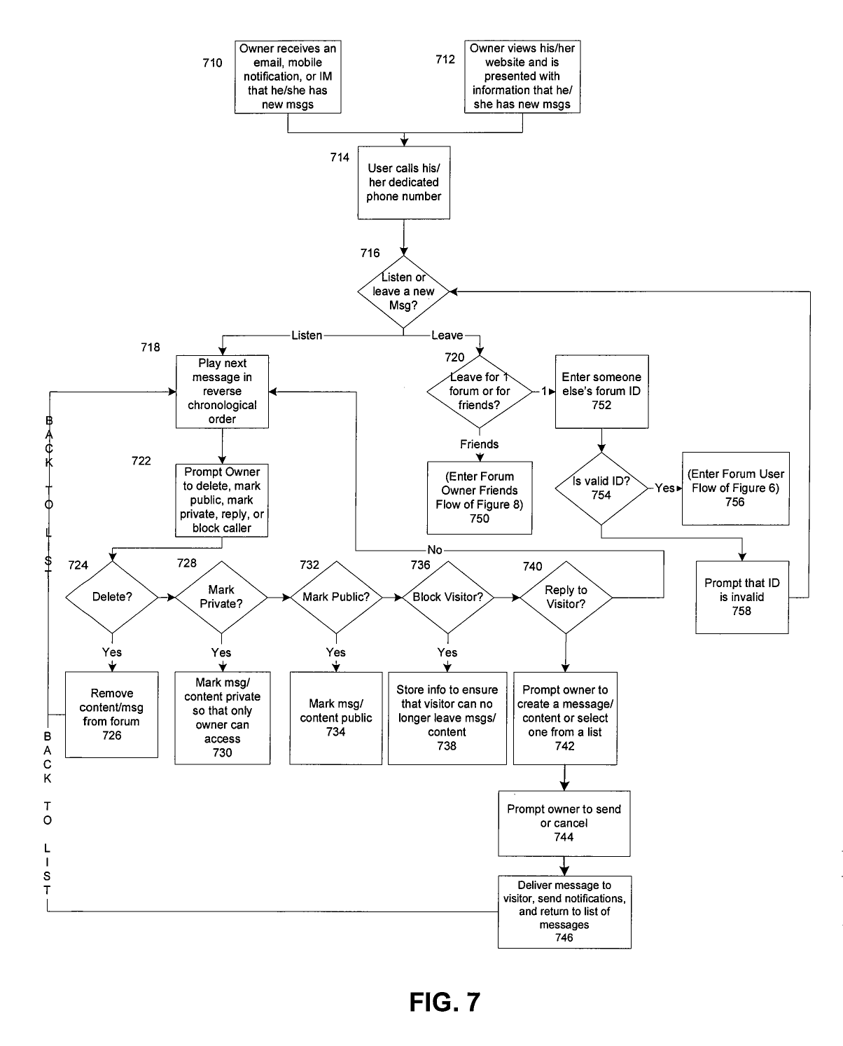

FIG. 7 is a flowchart illustrating an example of how a forum owner or creator might interact with that forum in accordance with an embodiment of the present invention. At stage 710 or 712, the owner of the voice forum receives some form of alert or notification that new messages or content are available. The alert may be email based, application based, a visual indicator within an embedded application, a SMS/MMS message to their mobile device, an IM (depicted in stage 710), and/or an dynamic text/visual alert that appears on the owner's profile page, such as a social network web-site (stage 712).

In response to the alert or notification, the forum owner calls a phone number and is asked to authenticate or verify their identity (stage 714). Note that authentication may be performed automatically by recognizing the owner's caller ID. It may also be accomplished by recognizing the caller ID and requiring input of a shared secret or identification number or string (e.g., a PIN). Control is then passed to stage 716, where the forum owner is prompted as to whether they desire to either interact with content that has been assigned to his/her forum (“Listen”) or to leave content for another forum (“Leave a New Message”). If the forum owner desires to listen to content on their own forum (played back in reverse chronological order, for example), control is passed to stage 718. If the forum owner desires to leave content for another forum, control is passed to stage 720.

If control is passed to stage 718, then after each piece of content has been provided to the owner, the owner is prompted to select one or more management options for processing of that content (e.g., delete, mark public, mark private, reply, or block caller). If the forum owner selects the option of deleting the content, then control is passed to stage 724. After confirmation of the delete operation at stage 724, the content is removed from the forum at stage 726 and control is passed back to stage 718.

If the forum owner selects the “mark private” operation, then control is passed to stage 728 and after confirmation, the message or content is marked private so that only the forum owner can have access to the message or content (stage 730), and control is passed back to stage 718. If the message or content has already been marked private by the creator of the content, the forum owner has the option of marking the content as public, as indicated at stage 732. If the marking public operation is confirmed, then the system will mark the message or content as public so that it will be available to others who visit the forum (stage 734). Control is then passed back to stage 718.

If the forum owner desires to block the visitor who left the message or content from continuing to have access to the forum, or continuing to leave messages or content (stage 736), then after confirmation, relevant identification data for the visitor is stored so that the system can prevent the visitor from accessing the forum in the future or from having the ability to associate messages or content with the forum (stage 738). Control is then passed back to stage 718. If the forum owner wants to reply to the creator of the message or content (stage 740), then after confirmation the forum owner is prompted to prepare a message or select content from a list or other source (stage 742). Note that if the user chooses to use content created by another source (i.e., other than by themselves), a billing event can be triggered through Billing Gateway 160 that will charge the user for the content. The forum owner may then be prompted as to whether to send the message/content or cancel the delivery operation (stage 744). If the delivery option is selected, then the system processes the transmission and associates the message/content with the specified forum. Once the content has been associated, the system will notify the owner of the forum (i.e., the visitor who left the message or content) via one or more of the techniques mentioned previously (stage 746). Control is then passed back to stage 718.

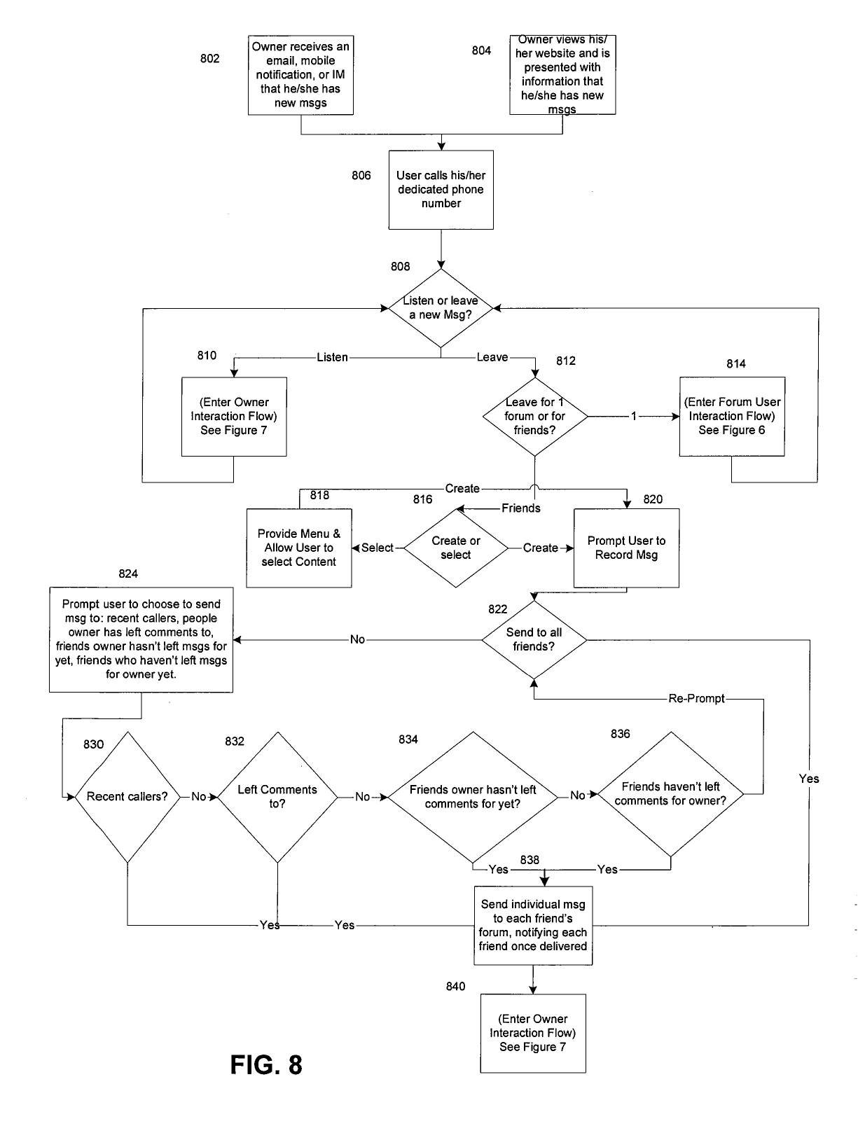

Returning to stage 720, if the forum owner desires to leave a message or content for another forum, they may be prompted as to whether they desire to leave the message or content for a specified forum (identified by its identification number) or for a friend's forum. If they desire to leave the message or content for a forum or forums belonging to a friend or group of friends, then control is passed to stage 750 and the process flow described with reference to FIG. 8 is executed. If the forum owner desires to leave a message or content for a forum by identifying a forum ID, then control is passed to stage 752. At this stage the forum owner enters a forum ID or chooses from a list that may be compiled from his/her friends/acquaintances, recent forums visited, etc. Next the process determines if the entered or selected forum ID is valid (stage 754). If the forum ID is valid, then control is passed to the process flow described with reference to FIG. 6 (stage 756). If the forum ID is invalid, then the forum owner is notified of the invalid ID and control is passed to stage 716.

FIG. 8 is a flowchart illustrating an example of how a forum owner or creator might leave a message or content for a friend or group of friends in accordance with an embodiment of the present invention. As noted when describing the process flow of FIG. 7, if the forum owner who is reviewing their own messages or posted content desires to leave a message or content for a friend or group of friends, then control is passed to stage 750 of FIG. 7 and the process flow to be described with reference to stage 812 (and subsequent stages) of FIG. 8 is executed. Note that as described with regard to FIG. 7, the owner may have entered the process of FIG. 7 by being notified of new messages or content via email, etc. (stage 802, as described with reference to stage 710 of FIG. 7) or by an alert or other message upon visiting their own profile page or other web-page (stage 804, as described with reference to stage 712 of FIG. 7). As described with reference to FIG. 7, if after reviewing messages or content in their own forum, a forum owner desires to leave or post a message or content for a friends or group of friends, the system passes control to stage 816 of FIG. 8 (from stage 750 of FIG. 7). At this stage the user is prompted to record/create a message (stage 820) or select content from a list or other source (stage 818) to provide to a friend or group of friends. Note that if the user chooses to use content created by another source (i.e., other than by themselves), a billing event can be triggered through Billing Gateway 160 that will charge the user for the content.

The user is then queried as to whether the message or content will be provided to all friends or to a subset of that group (stage 822). If the user responds that the message or content is to be provided to a subset of their group of friends, then they are prompted by one or more queries to choose which friends to provide the message or content to (stage 824). For example the user may be prompted as to whether they desire to send the message or content to friends who are recent callers to their forum (stage 830), friends who the forum owner has previously left messages or content for (stage 832), friends who the forum owner has not previously left messages or content for (stage 834), friends who have not yet left messages or content for the forum owner (stage 836), etc.

For each category of friends to whom the forum owner desires to leave a message or content, the system executes a process to send the message or content to a forum associated with each person in that category and notifies that person of the delivery of the message or content (stage 838). Control is then passed to back to the process flow of FIG. 7 (at stage 718), as shown in stage 840 of FIG. 8.

If at stage 822, the user responds that the message or content is to be provided to all friends, then control is passed to stage 838, and the process continues as described. In addition, if the user replies “No” to all queries regarding who to send the message or content to, then the process may re-prompt the user by returning control to stage 822.

A system and associated apparatus and methods for enabling members of a virtual community to interact by posting, sharing, and commenting on voice or audio content has been described. The inventive system provides for the recording of an audio message or content using a fixed line phone, mobile, phone or phone simulation software executing on a computing device. The system also enables a user to select audio content for posting to a voice forum using a web interface, as well as to register for and configure a voice forum using a phone keypad, interactive voice response system or web interface.

The voice forums enabled by the present invention can be publicly accessible, limited to a specified set or group, private, or some combination of these based on the content. The forums can be used for one-to-many communications, such as an audio/media web log. This may be accomplished by only allowing approved content from the forum owner to be available within the public version of the forum. The forums can be used for one-to-one communications, such as when a visitor replies via a private comment. The forums may also be used for many-to-one communications, in the manner in which celebrities/fans stay connected with their fan club(s).

The voice forums enabled by the invention may be configured to have an API to enable access to the forum via a Web Service and queries to the inventive system. In this case, an XML payload may contain information associated with the specified forum ID, including links to the media associated with the forum. An embedded (e.g., FLASH) or client application may use these APIs to access each of the users' forums, photos, audio messages, etc.

Note that due to the public/private nature of forums, one of the interaction components with a forum could involve commerce. In such a scenario, downloading audio or video content could cost the listener (similar to on-demand), or it could trigger a charge to the visitor. Thus, the forums may serve as a content discovery and distribution mechanism as well as a discussion forum. In one implementation, users will have accounts that can either be billed in advance (seeded accounts) or billed in arrears. Visitors and Users may be able to have the charges associated with their use of forum content billed to their phone bill, to their credit card, and/or depleted from points (virtual credit) that may have been associated with their account based upon their usage and interaction with the system, and/or their impact upon the behavior of other virtual community members. For instance, for each voice comment that a visitor or user leaves for another user, points could be assigned to the sender that can be used later as currency to offset the “cost” of acquiring content generated by another user.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

What is claimed is:

1. A method of enabling members of a virtual community to interact via a communication forum, comprising:
enabling a first member of the community to establish a forum account, the account established at least in part by accessing a web-site over the Internet;
enabling the first member of the community to provide content associated with the forum account, the content including audio content input to a telephony device;
enabling a second member of the virtual community to access the content provided by the first member;
enabling the second member to respond to the content provided by the first member by providing responsive content;
providing a notification to the first member that the second member has provided responsive content; and
enabling the first member of the community to access the responsive content.

2. The method of claim 1, wherein enabling the first member of the community to establish a forum account further comprises
accepting credential data input by the first member through the web-site;
accepting a telephone number input by the first member through the web-site; and
verifying the identity of the first member by contacting the first member at the telephone number.

3. The method of claim 1, wherein enabling the first member of the community to provide content associated with the forum account further comprises enabling the first member of the community to input audio content using a fixed line telephone.

4. The method of claim 1, wherein enabling the first member of the community to provide content associated with the forum account further comprises enabling the first member of the community to input audio content using a mobile telephone.

5. The method of claim 1, wherein enabling the first member of the community to provide content associated with the forum account further comprises enabling the first member of the community to provide one of an image, video, or text content that is accessible by the second member of the community.

6. The method of claim 1, wherein enabling the first member of the community to provide content associated with the forum account further comprises:
enabling the first member to select content provided by another source; and
generating a billing event charging the first member for that content.

7. The method of claim 1, wherein enabling the second member of the virtual community to access the content provided by the first member further comprises enabling the second member of the community to access the content using a telephone connected to a fixed line network.

8. The method of claim 1, wherein enabling the second member of the virtual community to access the content provided by the first member further comprises enabling the second member of the community to access the content using a telephone connected to a wireless network.

9. The method of claim 1, wherein enabling the second member of the virtual community to access the content provided by the first member further comprises enabling the second member of the community to access the content using a VoIP connection.

10. The method of claim 1, wherein enabling the second member to respond to the content provided by the first member by providing responsive content further comprises enabling the second member to provide one of an image, video, audio content or text content.

11. The method of claim 1, wherein providing a notification to the first member that the second member has provided responsive content further comprises providing the notification using one of a SMS message, email, web-site indication, or telephone call.

12. The method of claim 1, wherein enabling the first member of the community to access the responsive content further comprises enabling the first member to access the content using one of a fixed line telephone, mobile telephone, web-site, or VoIP connection.

13. A system to enable members of a virtual community to interact via a communication forum, comprising:
a VoIP/PSTN gateway coupling a telephony network to the Internet; and
a Voice Applications element coupled to the Internet and configured to enable execution of a communication forum application, the communication forum application including a set of executable instructions, which when executed, implement a process that includes
enabling a first member of the community to establish a forum account, the account established at least in part by accessing a web-site over the Internet;
enabling the first member of the community to provide content associated with the forum account, the content including audio content input to a telephony device;
enabling a second member of the virtual community to access the content provided by the first member;
enabling the second member to respond to the content provided by the first member by providing responsive content;
providing a notification to the first member that the second member has provided responsive content; and
enabling the first member of the community to access the responsive content.

14. The system of claim 13, wherein the telephony network is a fixed line network.

15. The system of claim 13, wherein the telephony network is a wireless network.

16. The system of claim 13, wherein enabling the first member of the community to establish a forum account further comprises
accepting credential data input by the first member through the web-site;
accepting a telephone number input by the first member through the web-site; and
verifying the identity of the first member by contacting the first member at the telephone number.

17. The system of claim 13, wherein enabling the first member of the community to provide content associated with the forum account further comprises enabling the first member of the community to provide one of an image, video, or text content that is accessible by the second member of the community.

18. The system of claim 13, wherein enabling the second member to respond to the content provided by the first member by providing responsive content further comprises enabling the second member to provide one of an image, video, audio content or text content.

19. The system of claim 13, wherein providing a notification to the first member that the second member has provided responsive content further comprises providing the notification using one of a SMS message, email, web-site indication, or telephone call.

20. The system of claim 13, wherein enabling the first member of the community to access the responsive content further comprises enabling the first member to access the content using one of a fixed line telephone, mobile telephone, web-site, or VoIP connection.
